(19) United States
(12) Patent Application Publication
(10) Pub. No.: US 2023/0031637 A1
(43) Pub. Date: Feb. 2, 2023

(54) METHODS FOR INCREASING NUMBER OF DISPENSABLE PACKETS WITHIN COUNTERMEASURE EXPENDABLES

(71) Applicant: BAE Systems Information and Electronic Systems Integration Inc., Nashua, NH (US)

(72) Inventors: Loman D. Milliorn, JR., Meadowlakes, TX (US); Mark J. Dube, McDade, TX (US); Danny L. Plemons, Austin, TX (US)

(73) Assignee: BAE Systems Information and Electronic Systems Integration Inc., Nashua, NH (US)

(21) Appl. No.: 17/391,699

(22) Filed: Aug. 2, 2021

(51) Int. Cl. F41A 19/68; B64D 7/00

(52) U.S. Cl. CPC F41A 19/68; B64D 7/00

(57) ABSTRACT

Various countermeasure expendables and methods of using said countermeasure expendables are provided herein. The countermeasure expendable includes a container. The countermeasure expendable also includes a plurality of countermeasure payloads operably engaged inside the container, wherein one countermeasure payload of the plurality of countermeasure payloads is operably connected to a first Zener diode, and wherein another countermeasure packet of the plurality of countermeasure packets is operably connected to a second Zener diode. In addition, the first Zener diode has a first Zener voltage threshold and the second Zener diode has a second Zener voltage threshold greater than the first Zener voltage threshold.

### TECHNICAL FIELD

The present disclosure generally relates to aircraft defense systems. More particularly, the present disclosure relates to a countermeasure dispensing system (CMDS). Specifically, the present disclosure relates to methods for increasing number of dispensable packets within countermeasure expendables.

### BACKGROUND

In current military technologies, military platforms, such as a military aircraft, include at least one CMDS. The CMDS dispenses expendables (i.e., chaff material or flares) from the platform in order to counter a detected incoming threat, such as a missile, and redirect such incoming threat away from the platform. In a conventional CMDS, such as the AN/ALE-47 CMDS used on an aircraft, a CMDS generally comprises a cockpit control unit that provides an interface with the operator of the military platform, sequencer units that control countermeasure dispensers, and a programmer that may provide additional features and characteristics for a CMDS. Each countermeasure dispenser in a CMDS is electrically connected to a sequencer unit for dispensing the expendables. However, the traditional countermeasure dispenser in a CMDS is limited to only carrying thirty (30) expendables with a corresponding sequencer having thirty (30) firing lines to dispense said expendables. Such limit of expendables and firing lines in the CMDS may cause issues during military operation when many expendables must be dispensed from the CMDS in critical situations. The countermeasure dispenser and the sequencer in a CMDS also limits the capability of expanding the amount of expendables that may be provided on a military platform without removing and replacing the existing countermeasure dispenser and sequencer unit.

### SUMMARY

The presently disclosed countermeasure expendables allows a military platform to utilize its legacy CMDS while increasing the number of dispensable packets per countermeasure expendable on said military platform. The disclosed countermeasure expendables may allow the legacy CMDS to fire and dispense variably volumes of countermeasure material (e.g., chaff) during a military operation to deter enemy threats away from the military platform. The disclosed countermeasure expendables may also allow the legacy CMDS to fire and dispense dispensable packets independently inside a single countermeasure expendable during a military operation to deter enemy threats away from the military platform. As such, the countermeasure expendables described and illustrated herein addresses some of the inadequacies and detriments of previously known countermeasure expendables.

In one aspect, an exemplary embodiment of the present disclosure may provide a countermeasure expendable. The countermeasure expendable includes a container. The countermeasure expendable also includes a plurality of countermeasure payloads operably engaged inside the container, wherein one countermeasure payload of the plurality of countermeasure payloads is operably connected to a first Zener diode, and wherein another countermeasure packet of the plurality of countermeasure packets is operably connected to a second Zener diode.

This exemplary embodiment or another exemplary embodiment may further provide that the first Zener diode has a first Zener voltage threshold and the second Zener diode has a second Zener voltage threshold greater than the first Zener voltage threshold. This exemplary embodiment or another exemplary embodiment may further provide that the plurality of countermeasure payloads further comprises a first countermeasure payload; a second countermeasure payload operably connected to the first Zener diode having a first Zener voltage threshold; and a third countermeasure payload operably connected to the second Zener diode having a second Zener voltage threshold greater than the first Zener voltage threshold. This exemplary embodiment or another exemplary embodiment may further provide that the first countermeasure payload is adapted to be dispensed at a first voltage via a sequencer operably engaged to said first countermeasure payload. This exemplary embodiment or another exemplary embodiment may further provide that the second countermeasure payload is adapted to be dispensed at a second voltage via the sequencer operably engaged to said second countermeasure payload, and wherein the second voltage is greater than the first voltage. This exemplary embodiment or another exemplary embodiment may further provide that the third countermeasure payload is adapted to be dispensed at a third voltage via the sequencer operably engaged to said third countermeasure payload, and wherein the third voltage is greater than the first and second voltages. This exemplary embodiment or another exemplary embodiment may further provide that a fourth countermeasure payload operably connected to a third Zener diode having a third Zener voltage threshold greater than the first Zener voltage threshold and the second Zener voltage threshold. This exemplary embodiment or another exemplary embodiment may further provide that the fourth countermeasure payload is adapted to be dispensed at a fourth voltage via the sequencer operably engaged to said fourth countermeasure payload, and wherein the fourth voltage is greater than the first, second, and third voltages. This exemplary embodiment or another exemplary embodiment may further provide that each countermeasure payload of the plurality of countermeasure payloads is arranged end-to-end inside of the container. This exemplary embodiment or another exemplary embodiment may further provide that each countermeasure payload of the plurality of countermeasure payloads is arranged side-by-side inside of the container.

In another aspect, an exemplary embodiment of the present disclosure may provide a method. The method comprises the steps of loading a plurality of countermeasure payloads into each countermeasure expendables of a plurality of countermeasure expendables; effecting the plurality of countermeasure expendables to be loaded into a magazine; effecting the magazine to be loaded into a dispenser on a platform; effecting a countermeasure dispensing system to initiate; effecting at least one firing pin from a set of firing pins to be selected, wherein the at least one firing pin from the set of firing pins is electrically connected to a countermeasure expendable from the plurality of countermeasure expendables; effecting a first dispensing signal to be sent, by a sequencer, to the at least one firing pin in the set of firing pins; effecting a first voltage to be provided with the first dispensing signal; effecting a first countermeasure payload from the countermeasure expendable to be dispensed via a bridge wire operably connecting the at least one firing pin with the first countermeasure payload; and effecting a first return signal to be sent to the sequencer to determine that the first countermeasure payload has been dispensed.

This exemplary embodiment or another exemplary embodiment may further provide that the step of effecting a first voltage to be provided with the first dispensing signal includes the first voltage being less than a first Zener voltage of a first Zener diode that is in series with the sequencer. This exemplary embodiment or another exemplary embodiment may further provide the steps of effecting a second dispensing signal to be sent, by the sequencer, to the at least one firing pin in the set of firing pins; effecting a second voltage to be provided with the second dispensing signal, wherein the first Zener diode is in series with the sequencer; effecting a second countermeasure payload from the countermeasure expendable to be dispensed via the bridge wire operably connecting the at least one firing pin with the second countermeasure payload, wherein the first Zener diode is in series with the second countermeasure payload; and effecting a second return signal to be sent to the sequencer to determine that the second countermeasure payload has been dispensed. This exemplary embodiment or another exemplary embodiment may further provide that the step of effecting a second voltage to be provided with the second dispensing signal includes the second voltage being greater than the first Zener voltage threshold of the first Zener diode. This exemplary embodiment or another exemplary embodiment may further provide the steps of effecting a third dispensing signal to be sent, by the sequencer, to the at least one firing pin in the set of firing pins; effecting a third voltage to be provided with the third dispensing signal, wherein the second Zener diode is in series with the sequencer; effecting a third countermeasure payload from the countermeasure expendable to be dispensed via the bridge wire operably connecting the at least one firing pin with the third countermeasure payload, wherein the second Zener diode is in series with the third countermeasure payload; and effecting a third return signal to be sent to the sequencer to determine that the third countermeasure payload has been dispensed. This exemplary embodiment or another exemplary embodiment may further provide that the step of effecting a third voltage to be provided with the third dispensing signal includes the third voltage being greater than the second Zener voltage threshold of the second Zener diode. This exemplary embodiment or another exemplary embodiment may further provide the steps of effecting a fourth dispensing signal to be sent, by the sequencer, to the at least one firing pin in the set of firing pins; effecting a fourth voltage to be provided with the fourth dispensing signal, wherein the third Zener diode is in series with the sequencer; effecting a fourth countermeasure payload from the countermeasure expendable to be dispensed via the bridge wire operably connecting the at least one firing pin with the fourth countermeasure payload, wherein the third Zener diode is in series with the fourth countermeasure payload; and effecting a fourth return signal to be sent to the sequencer to determine that the fourth countermeasure payload has been dispensed. This exemplary embodiment or another exemplary embodiment may further provide that the step of effecting a fourth voltage to be provided with the fourth dispensing signal includes the fourth voltage being greater than the third Zener voltage threshold of the third Zener diode. This exemplary embodiment or another exemplary embodiment may further provide the step of positioning each countermeasure payload of the plurality of countermeasure payloads in an end-to-end configuration inside a countermeasure expendable of the plurality of countermeasure expendables. This exemplary embodiment or another exemplary embodiment may further provide the step of positioning each countermeasure payload of the plurality of countermeasure payloads in a side-by-side configuration inside a countermeasure expendable of the plurality of countermeasure expendables.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 (FIG. 1) is a diagrammatic view showing a platform having a legacy CMDS with countermeasure payloads in accordance with an aspect of the present disclosure, wherein the legacy CMDS with the countermeasure payloads are being used when an incoming enemy threat is detected

FIG. 2 (FIG. 2) is top, front, right side isometric perspective view of a magazine housing a plurality of countermeasure expendables, wherein a countermeasure expendable is exploded from the magazine to show the orientation of loading a countermeasure expendable into the magazine in the direction of line A-A.

FIG. 3 (FIG. 3) is a front elevation view of a countermeasure expendable from the plurality of countermeasure expendables.

FIG. 4 (FIG. 4) is a side sectional view of a countermeasure expendable from the plurality of countermeasure expendables taken in the direction of line 4-4, wherein the countermeasure expendable is operably connected to a sequencer of the legacy CMDS.

FIG. 4A (FIG. 4A) in an enlargement of the highlighted region in FIG. 4.

FIG. 5 (FIG. 5) is an electrical circuit diagram of a countermeasure expendable from the plurality of countermeasure expendables in FIG. 4.

FIG. 6A (FIG. 6A) is a side sectional view of a countermeasure expendable from the plurality of countermeasure expendables, wherein a first countermeasure payload of the countermeasure expendable is initiated by the sequencer.

FIG. 6B (FIG. 6B) is a side sectional view of the countermeasure expendable similar to FIG. 6A, but the first countermeasure payload is ejected from a container of the countermeasure expendable.

FIG. 6C (FIG. 6C) is a side sectional view of the countermeasure expendable similar to FIG. 6B, but a second countermeasure payload of the countermeasure expendable is initiated by the sequencer.

FIG. 6D (FIG. 6D) is a side sectional view of the countermeasure expendable similar to FIG. 6D, but a third countermeasure payload of the countermeasure expendable is initiated by the sequencer.

FIG. 7 (FIG. 7) is a front elevation view of an alternative countermeasure expendable from a plurality of alternative countermeasure expendables, wherein the cover of the countermeasure expendable is removed.

FIG. 7A (FIG. 7A) is a top sectional plan view of the alternative countermeasure expendable in FIG. 7 taken in the direction of line 7A-7A in FIG. 7, wherein the countermeasure expendable is operably connected to a sequencer of the legacy CMDS.

FIG. 8 (FIG. 8) is a front elevation view of another alternative countermeasure expendable from a plurality of alternative countermeasure expendables, wherein the cover of the countermeasure expendable is removed.

FIG. 9 (FIG. 9) is an electrical circuit diagram of the alternative countermeasure expendable from the plurality of alternative countermeasure expendables in FIG. 8.

FIG. 10 (FIG. 10) is an exemplary method flowchart for dispensing countermeasure material.

Similar numbers refer to similar parts throughout the drawings.

### DETAILED DESCRIPTION

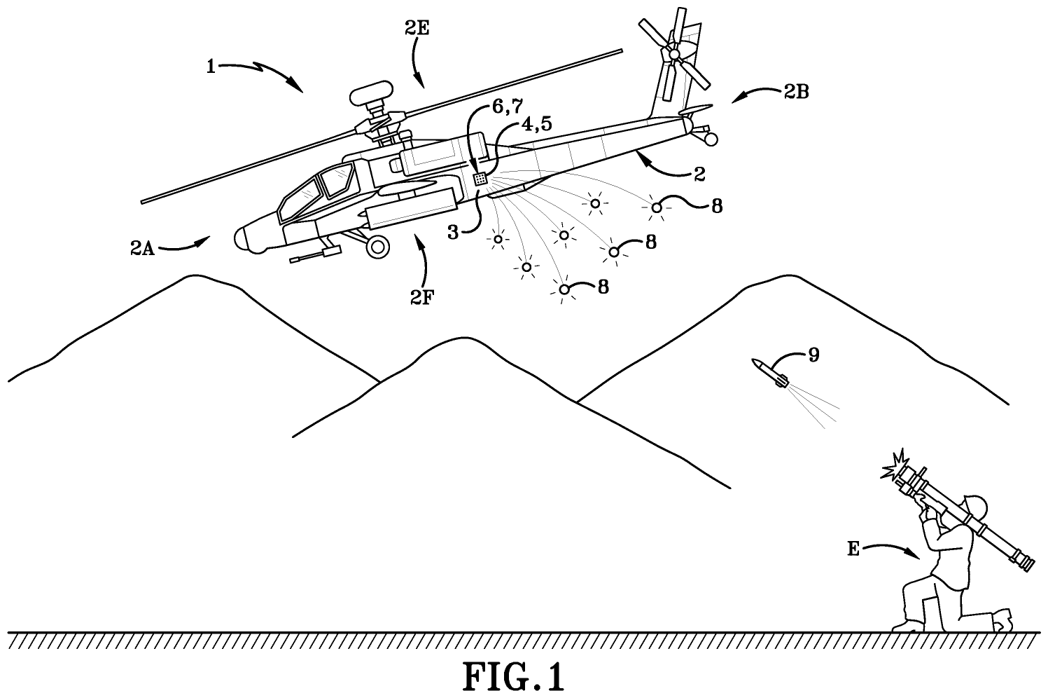

FIG. 1 illustrates a platform 1 such as a vehicle, ship or aircraft, which may be manned or unmanned, that includes a main body 2. As used herein, aircraft refers to fixed and rotary wing aircraft as well as UUVs and satellites. The main body 2 has a front end 2A and an opposed rear end 2B, a top end 2E, and an opposed bottom end 2F. It should be understood that the directions of “front,” “rear,” “top,” “bottom,” “right,” and “left” are only used as a directional reference for the main body 2 and its associated components and/or parts described herein and illustrated in FIG. 1.

The platform 1 in this example is an aircraft and includes a sidewall 3 that extends from the front end 2A of the main body 2 to the rear end 2B of the main body 2. The sidewall 3 defines an opening 4 that is disposed between the front and rear ends 2A, 2B of the main body 2 that provides access to a chamber 5. The opening 4 and the chamber 5 defined by the sidewall 3 is sized and configured to receive a countermeasure dispensing system 6 (or “CMDS” hereinafter). The CMDS 6 operably engages the sidewall 3 of the main body 2 to mechanically fix the CMDS 6 to the platform 1 inside of the chamber 5. Upon mounting the CMDS 6, the CMDS 6 is electrically connected to a legacy wiring harness (not illustrated) that is provided in the platform 1 to provide power and communication to all electrical components in the CMDS 6, which is described in more detail below.

Prior to military operation or an aerial mission of the platform 1, the CMDS is pre-loaded with a plurality of expendables 7. Each expendable of the plurality of expendables 7 is loaded with countermeasure material 8 for countermeasure purposes. In the illustrated embodiment, the plurality of expendables is loaded with chaff material. In addition, each expendable of the plurality of expendables 7 includes an impulse cartridge (not illustrated) for detonating and dispensing the expendable from the platform 1. During military operation, the countermeasure material 8 provides a distraction to an incoming enemy threat 9, initiated by an enemy “E”, where the incoming enemy threat 9 is diverted to the countermeasure material 8 while allowing the platform 1 to remain unscathed. During military operation or an aerial mission, the platform 1 may receive a warning from an on-board electronic warfare (EW) system regarding the incoming enemy threat 9 approaching the platform 1. Upon a determination made by the on-board EW system and/or an operator, the CMDS 6 dispenses a calculated amount of expendables of the plurality of expendables 7 that are disposed underneath, behind, or to the side of the platform 1. In addition, the CMDS 6 may also be provided along any suitable location of the platform 1 other than sidewall 3 of the main body 2. In one exemplary embodiment, a CMDS may be provided within a wing of an aircraft. In another exemplary embodiment, a CMDS may be provided in a fuselage or a pod disposed on an aircraft. In another exemplary embodiment, a CMDS may be provided on a separate device operably engaging an aircraft (e.g., a towable device).

The CMDS 6 includes a dispenser (not illustrated) that is electrically connected to a sequencer 10. Generally, the sequencer 10 of the CMDS 6 may be electrically connected to a breechplate (not illustrated) for operably controlling and dispensing countermeasure material 8 through a set of firing pins provided in the CDMS 6. The breechplate of the CMDS 6 may be operably engaged to a magazine 12. In addition, the breechplate and the magazine 12 are electrically connected to allow the sequencer 10 to discharge and dispense specific expendables from the magazine 12 via the firing pins on the breechplate. Such discharging capabilities of the expendables 7 from the magazine 12 are described in more detail below.

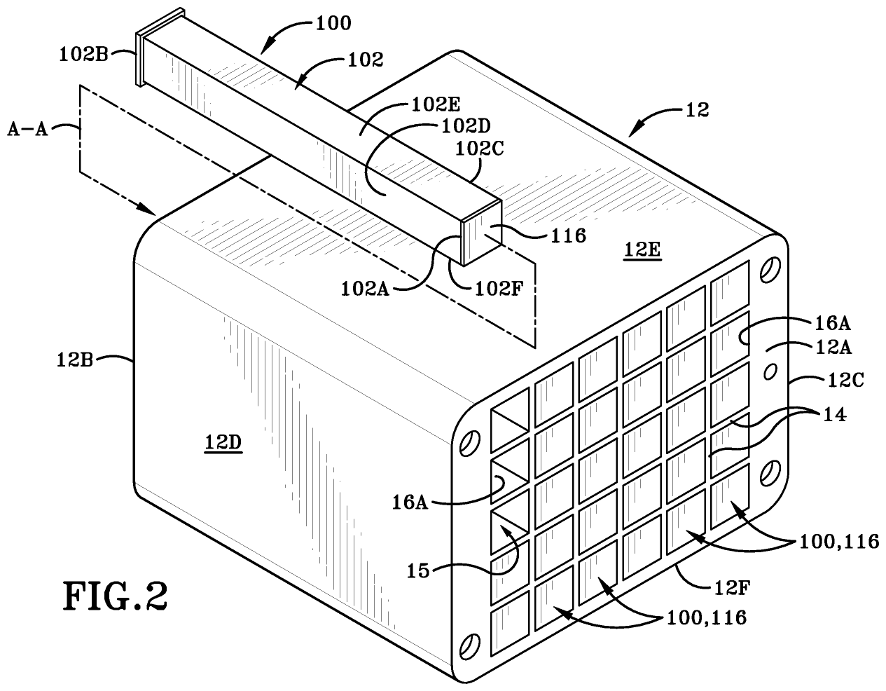

As illustrated in FIG. 2, the magazine 12 may include includes a front wall 12A, an opposed rear wall 12B, a pair of side walls 12C, 12D positioned parallel to one another and disposed between the front wall 12A and the rear wall 12B, a top wall 12E, and an opposed bottom wall 12F. The magazine 12 may also include a plurality of dividing walls 14 that collectively defines a plurality of passageways 15 that extends from the front wall 12A to the rear wall 12B. The magazine 12 also defines a front set of apertures 16A disposed proximate to the front wall 12A and a rear set of apertures (not illustrated) disposed proximate to the rear wall 12B. Each passageway in the plurality of passageways 15 has a front aperture from the front set of apertures 16A and a rear aperture from the rear set of aperture to receive and house a countermeasure expendable of a plurality of countermeasure expendables 100 (substantially similar to the countermeasure expendables 7 described above).

Referring to FIGS. 2-4A each countermeasure expendable from the plurality of countermeasure expendables 100 includes a container 102. The container 102 is loaded with a plurality of countermeasure payloads 104 where each countermeasure payload of the plurality of countermeasure payloads 104 has an impulse cartridge block or squib block 105A (“impulse cartridge” hereinafter) and a countermeasure packet 105B. Each countermeasure packet 105B provided in the countermeasure expendable 100 houses a volume of countermeasure material 106. Each impulse cartridge of the plurality of impulse cartridge 105A ejects and dispenses a volume of countermeasure material 106 from a respective countermeasure packet of the plurality of countermeasure packets 105B as initiated by the sequencer 10 during a military operation.

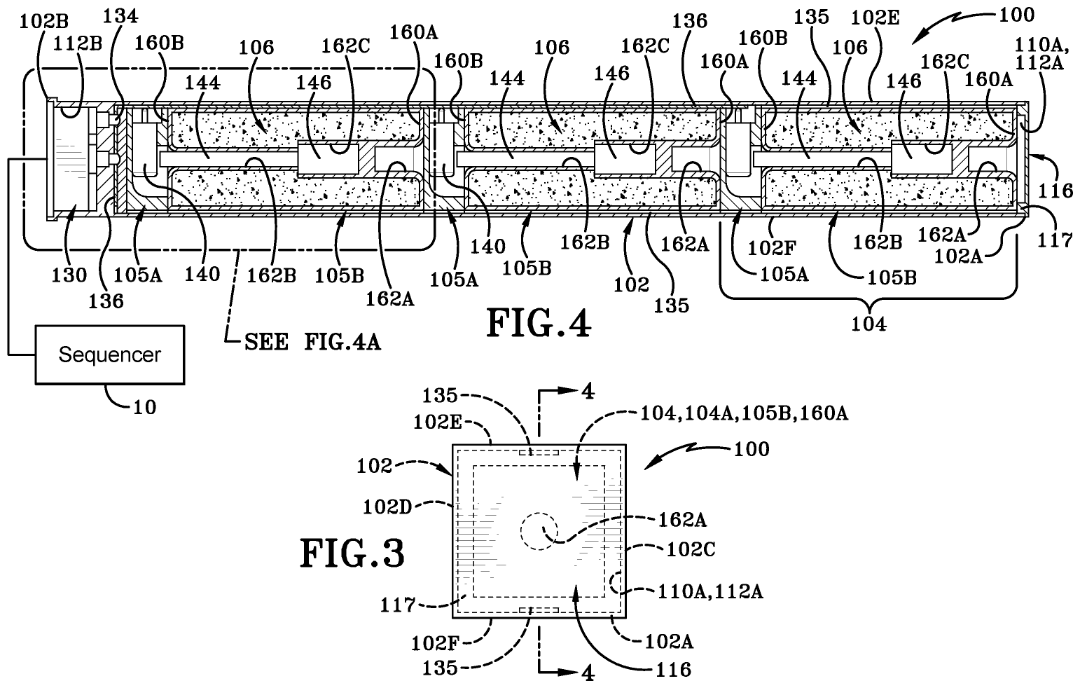

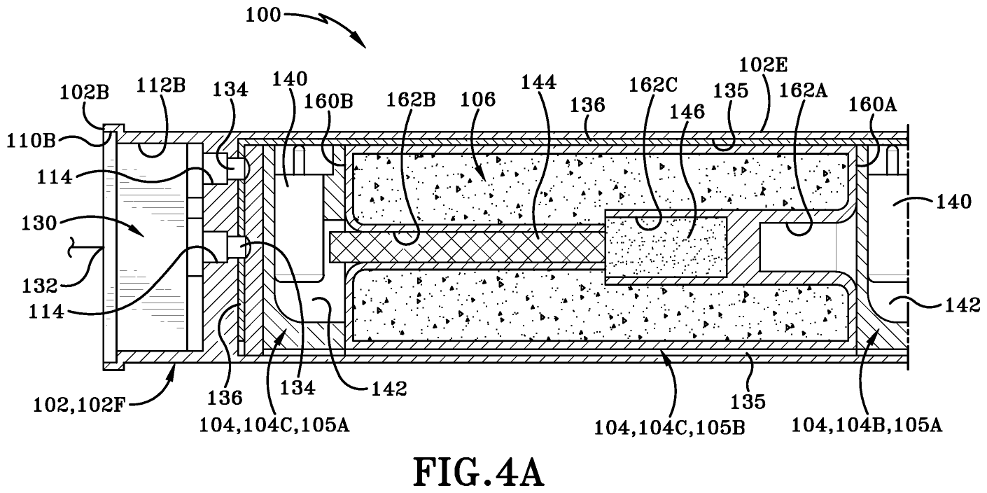

As illustrated in FIGS. 2 and 3, the container 102 includes a front end 102A, an opposed rear wall 102B, and a longitudinal axis that extends therebetween. The container 102 also includes a pair of side walls 102C, 102D positioned parallel to one another and disposed between the front end 102A and the rear wall 102B, a top wall 102E, and an opposed bottom wall 102F. As illustrated in FIGS. 2 and 4, the container 102 defines a front opening 110A that is disposed at the front end 102A of the container 102 and provides access to a front chamber 112A defined by the container 102. Still referring to FIG. 4, the container 102 also defines a rear opening 110B that is disposed at the rear end 102B of the container 102 and provides access to a rear chamber 112B defined by the container 102. In the illustrated embodiment, the front chamber 112A and the rear chamber 112B are separate from each other inside of the container 102. Still referring to FIG. 4, the container 102 defines a set of connecting passageways 114 that extends between the front chamber 112A to the rear chamber 112B. The set of connecting passageways 114 provide fluid communication between the front chamber 112A and the rear chamber 112B inside of the container 102. Such use of the set of connecting passageways 114 is described in more detail below.

Referring to FIGS. 3 and 4, a cover 116 may be operably engaged with the container 102 prior to ejecting and dispensing any countermeasure payload from the plurality of countermeasure payloads 104 from the countermeasure expendable 100. In the illustrated embodiment, the cover 116 is positioned over the front opening 110A and inside of the front chamber 112A of the container 102. The cover 116 may be used to maintain and hold the associated components inside of the front chamber 112A (e.g., countermeasure payloads 104) prior to a dispensing operation. In addition, the cover 116 may include an extension 117 that may operably engage with the container 102 to hold and maintaining the cover 116 with the container 102, which is described in more detail below.

Referring to FIGS. 3 through 4A, the container 102 includes an electrical block 130. The electrical block 130 operably engages with the container 102 inside of the rear chamber 112B defined by the container 102. The electrical block 130 also has a receptacle 132 that operably connects with a firing pin of a plurality of firing pins (not illustrated) of the breechplate as provided in legacy breechplates of legacy CMDS. Such engagement between the receptacle 132 and a firing pin of a plurality of firing pins allows the sequencer 10 to send signals and/or pulses to the countermeasure expendable 100 for ejecting and dispensing specific countermeasure payloads 104 loaded in said countermeasure expendable 100. Such operation between the sequencer 10 and each countermeasure expendable 100 is described in more detail below.

The electrical block 130 also includes a set of connector pins 134 that extends from the rear chamber 112B, through the set of connecting passageways 114, and into the front chamber 112A. The set of connector pins 134 is also electrically connected to a bridge wire 136 that is positioned inside of the front chamber 112A of the container 102. The bridge wire 136 may be placed in an upper or lower recess 135 that is defined by the container 102 between the front end 102A and the rear end 102B (see FIGS. 3 and 4A). The bridge wire 136 operably connects each impulse cartridge 105A of the plurality of impulse cartridge 105A to the sequencer 10 to allow the sequencer 10 to sequentially and individually eject and dispense each countermeasure packet of the plurality of countermeasure packets 105B from the container 102. Such sequential and individual ejection of each countermeasure packet of the plurality of countermeasure packets 105B from the container 102 is described in more detail below.

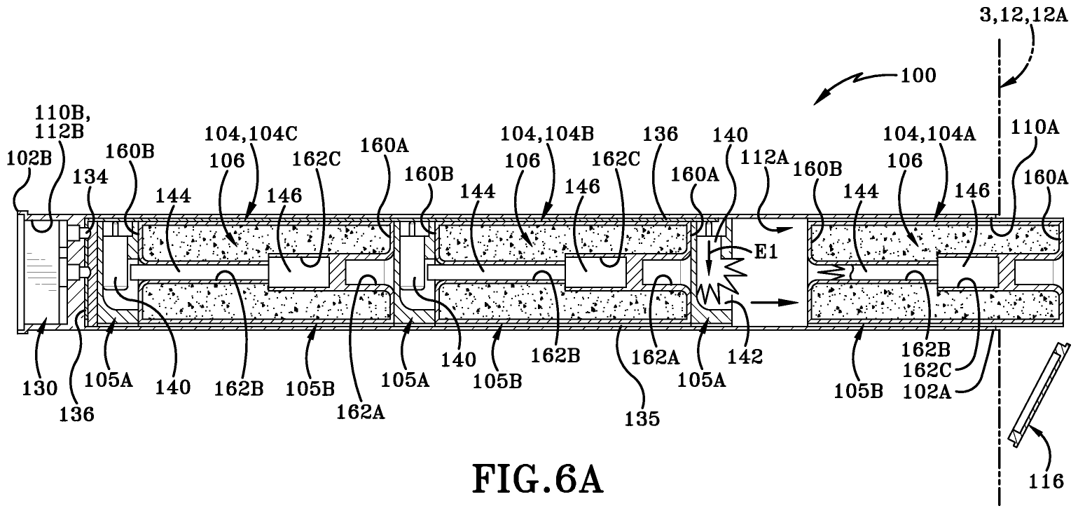

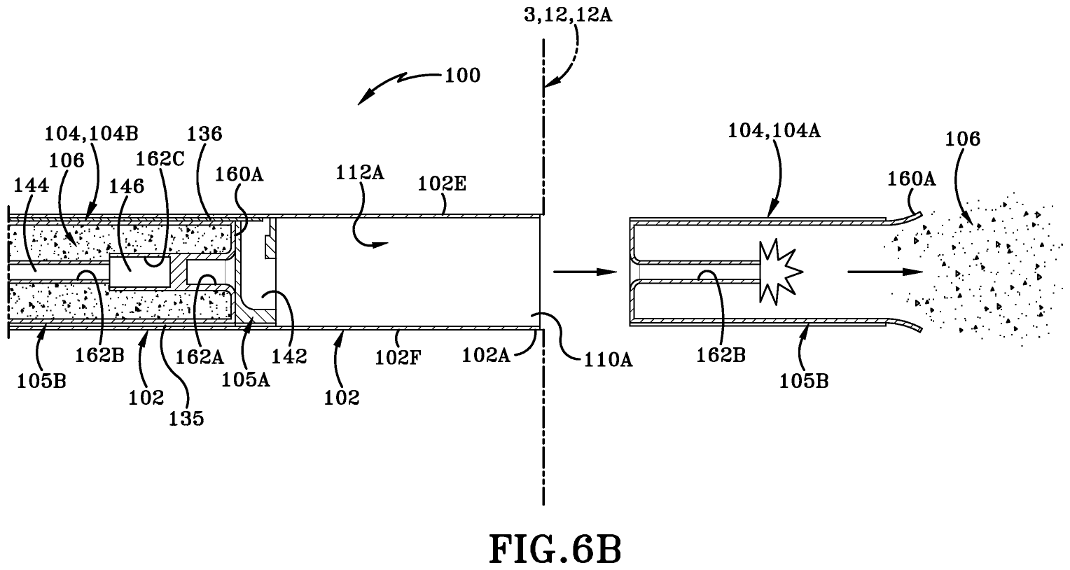

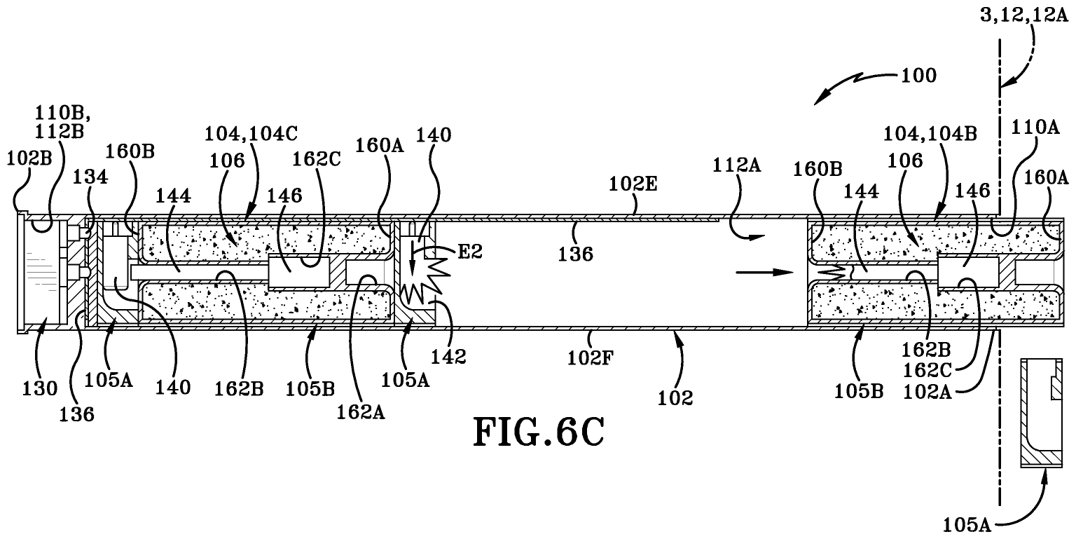

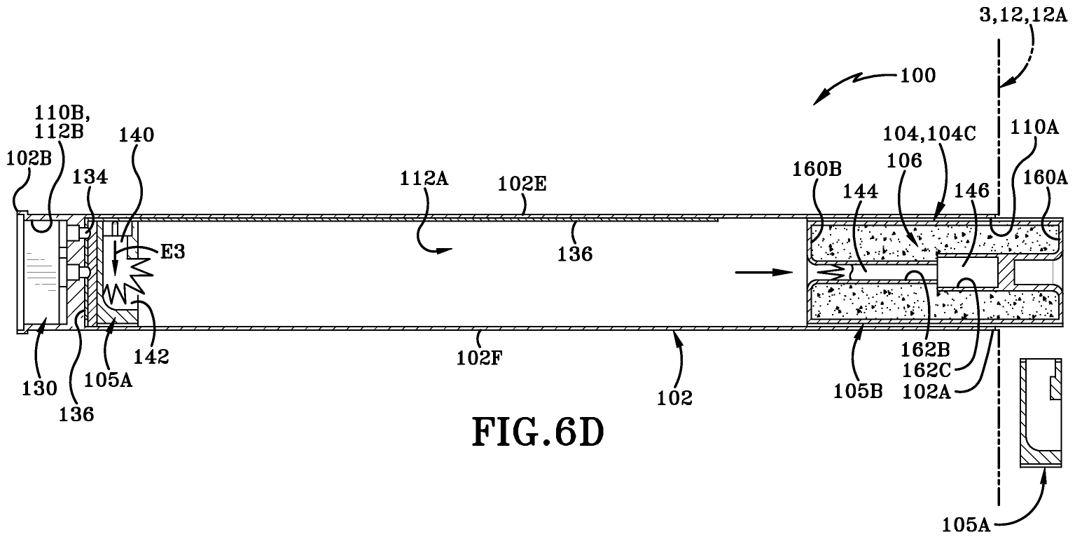

The countermeasure expendable 100 also includes the plurality of countermeasure payload 104. In the illustrated embodiment, each countermeasure payload of the plurality of countermeasure payloads 104 is arranged end-to-end inside of the container 102 (see FIGS. 4 and 6A-6F). Each countermeasure payload of the plurality of countermeasure payloads 104 includes an impulse cartridge 105A operably connected to a countermeasure packet 105B. In the illustrated embodiment, the countermeasure payloads 104 are disposed inside of the front chamber 112A between the front opening 110A and the set of connecting passageways 114. The countermeasure payloads 104 are identical to one another in that the countermeasure payloads 104 have the same structural configuration and are electrically connected in the same way to the sequencer 10 via the bridge wire 136. Inasmuch as the countermeasure payloads 104 are identical, the following description will generally relate to a single countermeasure payload 104. It should be understood, however, that the description of the countermeasure payload 104 applies equally to all other countermeasure payloads described and illustrated herein.

As illustrated in FIGS. 4 and 4A, the impulse cartridge 105A includes an ignitable energy pellet 140 that is formed of energetic material and is electrically connected to the bridge wire 136. The ignitable energy pellet 140 operably initiates the ejection and dispensing of the countermeasure material 106 from the countermeasure packet 105B via a signal or pulse sent from the sequencer 10 during a military operation. In addition, the impulse cartridge 105A includes a pressure chamber 142 that houses the ignitable energy pellet 140. The pressure chamber 142 retains and directs the energy created by the ignitable energy pellet 140 towards a fuse 144 to ignite and/or enable a bursting charge 146 after ejection in the countermeasure payload 104 during a military operation. Each of the fuse 144 and the bursting charge 146 is disposed inside of the countermeasure packet 105B to effectively eject and discharge the countermeasure material 106 from the countermeasure packet 105B. Such use of the impulse cartridge 105A to eject and dispense countermeasure material 106 during a military operation is described in more detail below. In one exemplary embodiment, a piece of material may encase and/or enclose the bridge wire 136 away from the pins 134 and the ignitable energy pellet 140 to prevent against any accidental energy discharge.

Still referring to FIGS. 4 through 4A, the countermeasure packet 105B includes front end 160A, an opposed rear end 160B, and a longitudinal axis defined therebetween. The countermeasure packet 105B also defines a front cavity 162A that extends from the front end 160A towards the rear end 160B of the countermeasure packet 105B. As illustrated in FIG. 4, the front cavity 162A is adapted to help dispense and/or eject a countermeasure material 106 from each countermeasure payload 104. The countermeasure packet 105B also defines a rear passage 162B that extends from the rear end 160B towards the front end 160A. The rear passage 162B is sized and configured to receive and house a portion of the fuse 144. The rear passage 162B of the countermeasure packet 105B is also in fluid communication with the pressure chamber 142 of the countermeasure packet 105B. In addition, a cylindrical wall may be formed between the front cavity 162A and the rear passage 162B of the countermeasure packet 105B. The cylindrical wall may provide a barrier between the fuse 144 and the bursting charge 146. Moreover, the formation of the front cavity 162A and the rear passage 162B may provide assistance in dispensing the chaff material 106 from the countermeasure packet 105B.

The countermeasure packet 105B also defines a central cavity 162C that is disposed between the front cavity 162A and the rear passage 162B. The central cavity 162C is sized and configured to receive and house the bursting charge 146. In the illustrated embodiment, the central cavity 162C is in fluid communication with the rear passage 162B to allow fuse 144 to interact with the bursting charge 146 during a military operation.

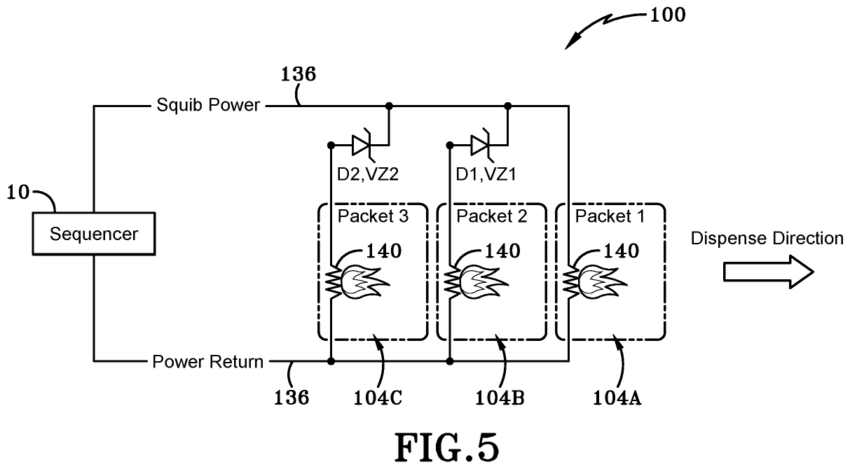

As illustrated in FIG. 5, the circuitry of the countermeasure expendable 100 includes the electrical circuitry that is able to leverage the legacy sequencer 10 of the legacy CMDS 6 to dispense additional countermeasure payloads 104 from a countermeasure expendable 100. The sequencer 10 is electrically connected to each countermeasure expendable of the plurality of countermeasure expendables 100 by electrically connecting each firing pin of the plurality of firing pins with the electrical block 130 of each countermeasure expendable 100. In the illustrated embodiment, the sequencer 10 is electrically connected to each countermeasure payload of the plurality of countermeasure payloads 104 provided in each countermeasure expendable 100 via the bridge wire 136.

Still referring to FIG. 5, the sequencer 10 is electrically connected to a first countermeasure payload 104A via the bridge wire 136. The bridge wire 136 allows the sequencer 10 to be in series with the first countermeasure payload 104A such that the first countermeasure payload 104A is free from any electrical devices or components. Still referring to FIG. 5, the sequencer 10 is also electrically connected to a second countermeasure payload 104B via the bridge wire 136. The bridge wire 136 allows the sequencer 10 to be in series with the second countermeasure payload 104B. However, a first Zener diode “D1” may be embedded with the second countermeasure payload 104B such that the sequencer 10 is in series with the first Zener diode “D1” and the second countermeasure payload 104B. The first Zener diode “D1” that is embedded in the second countermeasure payload 104B has a first Zener voltage threshold “VZ1” that may be overcome by a required first voltage, which is described in more detail below. Still referring to FIG. 5, the sequencer 10 is also electrically connected to a third countermeasure payload 104C via the bridge wire 136. The bridge wire 136 allows the sequencer 10 to be in series with the third countermeasure payload 104C. However, a second Zener diode “D2” may be embedded in the third countermeasure payload 104C such that the sequencer 10 is in series with the second Zener diode “D2” and the third countermeasure payload 104C. The second Zener diode “D2” that is embedded in the third countermeasure payload 104C has a second Zener voltage threshold “VZ2” that must be overcome by a required second voltage, which is described in more detail below.

While a single Zener diode, such as Zener diodes “D1”, “D2”, may be embedded in a countermeasure payload, such as second and third countermeasure payloads 104B, 104C, any suitable number of Zener diodes may be included in a countermeasure expendable for a particular purpose and/or application. In one exemplary embodiment, a plurality of Zener diodes may be electrically connected in series with one another for a single countermeasure payload.

Having now described the components and parts of the countermeasure expendable 100, methods of using the countermeasure expendable 100 during a military operation may now be described hereafter.

During operation of the electrical configuration, the sequencer 10 is able to send signals and/or pulses with different voltages to the countermeasure expendable 100, via a firing pin operably engaged with the countermeasure expendable 100, to eject and dispense different countermeasure payloads 104 with different electrical circuitry.

As illustrated in FIG. 6A, the sequencer 10 may send a first signal to countermeasure expendable 100 via the firing pin operably engaged with said countermeasure expendable 100. The first signal sent by the sequencer 10 is relayed from the electrical block 130, through the connector pins 134, to a first countermeasure payload 104A, via the bridge wire 136, to fire the first countermeasure payload 104A. The first signal sent by the sequencer 10 to the first countermeasure payload 104A includes a first voltage “V₁”. In one exemplary embodiment, a first voltage of a first signal sent from a sequencer to a countermeasure expendable may be in a range from about six volts up to about six and one-half volts when five amps is conducted through a one-ohm squib. The first voltage “V₁” of the first signal sent by the sequencer 10 is less than the first and second Zener voltage thresholds “VZ1”, “VZ2” of the first and second Zener diodes “D1”, “D2”. The first voltage “V1” of the first signal is less than the first and second Zener voltage thresholds “VZ1”, “VZ2” so that the first signal bypasses the second and third countermeasure payloads 104B, 104C and only ejects and dispenses the first countermeasure payload 104A.

Still referring to FIG. 6A, the first signal sent to the first countermeasure payload 104A initiates an ignitable energy pellet 140 of the first countermeasure payload 104A. Once initiated, the ignitable energy pellet 140 sends/propels energy into a pressure chamber 142 of the impulse cartridge 105A. The energy propelled by the ignitable energy pellet 140 is denoted by an arrow labeled “E1.” Once the energy is sent into the pressure chamber 142, the pressure chamber 142 directs the energy towards a fuse 144 of the first countermeasure payload 104A to ignite the fuse 144. Additionally, the energy directed from the pressure chamber 142 also provides a suitable amount of force to eject the first countermeasure payload 104A and the associated countermeasure packet 105B from the container 102. Upon ejection as shown in FIG. 6B, the countermeasure material 106 remains inside of the countermeasure packet 105B of the first countermeasure payload 104A due to time delay of the fuse 144. As such, the fuse 144 ignites a bursting charge 146 of the first countermeasure payload 104A after the first countermeasure payload 104A is ejected from the container 102.

As the fuse 144 reaches the bursting charge 146, the bursting charge 146 is enabled by the fuse 144 to rupture and/or open the countermeasure packet 105B of the first countermeasure payload 104A outside of the container 102 and away from the platform 1. Once ruptured, the countermeasure material 106 loaded inside of the countermeasure packet 105B is ejected away from the container 102 and into the surrounding environment of platform 1 to deter enemy threats away from the said platform (see FIG. 1 for such deterrence). Once the first countermeasure payload 104A has been ejected and dispensed from the platform 1, a first relayed signal is returned back to the sequencer 10 to signify that the first countermeasure payload 104A of the selected countermeasure expendable 100 has been used. The sequencer 10 may record or keep this information to determine that the selected countermeasure expendable 100 has one less countermeasure payload 104 available.

As illustrated in FIG. 6C, the sequencer 10 may send a second signal to countermeasure expendable 100 via the firing pin operably engaged with said countermeasure expendable 100. The second signal sent by the sequencer 10 is relayed from the electrical block 130, through the connector pins 134, to a second countermeasure payload 104B, via the bridge wire 136, to fire the second countermeasure payload 104B. The second signal sent by the sequencer 10 to the second countermeasure payload 104B includes a second voltage “V2” that may overcome the first Zener voltage threshold “VZ1” of the first Zener diode “D1”. In one exemplary embodiment, a second voltage of a second signal sent from a sequencer to a countermeasure expendable may be in a range from about twelve volts up to about thirteen volts when five amps is conducted through a one-ohm squib. The second voltage “V₂” of the second signal sent by the sequencer 10 is greater than the first voltage “V₁” of the first signal and less than the second Zener voltage threshold “VZ2” of the second Zener diodes “D2”. The second voltage “V₂” of the second signal is less than the second Zener voltage threshold “VZ2” so that the second signal bypasses the third countermeasure payloads 104C and ejects the second countermeasure payload 104B. In other words, the second signal is only able to overcome the first Zener voltage threshold “VZ1” of the first Zener diode “D1” to only fire the second countermeasure payload 104B.

Still referring to FIG. 6C, the second signal sent to the second countermeasure payload 104B initiates an ignitable energy pellet 140 of the second countermeasure payload 104B. Once initiated, the ignitable energy pellet 140 sends/propels energy into a pressure chamber 142 of the impulse cartridge 105A. The energy propelled by the ignitable energy pellet 140 is denoted by an arrow labeled “E2.” Once the energy is sent into the pressure chamber 142, the pressure chamber 142 directs the energy towards a fuse 144 of the second countermeasure payload 104B to ignite the fuse 144. Additionally, the energy directed from the pressure chamber 142 also provides a suitable amount of force to eject the second countermeasure payload 104B and the associated countermeasure packet 105B from the container 102. Upon ejection, the countermeasure material 106 remains inside of the countermeasure packet 105B of the second countermeasure payload 104B due to time delay of the fuse 144. As such, the fuse 144 ignites a bursting charge 146 of the second countermeasure payload 104B after the second countermeasure payload 104B is ejected from the container 102.

As the fuse 144 reaches the bursting charge 146, the bursting charge 146 is enabled by the fuse 144 to rupture and/or open the countermeasure packet 105B of the second countermeasure payload 104B outside of the container 102 and away from the platform 1 (substantially similar to the first countermeasure payload 104A shown in FIG. 66). Once ruptured, the countermeasure material 106 loaded inside of the countermeasure packet 105B is ejected away from the container 102 and into the surrounding environment of platform 1 to deter enemy threats away from the said platform (see FIG. 1 for such deterrence). Once the second countermeasure payload 104B has been ejected and dispensed from the platform 1, a second relayed signal is returned back to the sequencer 10 to signify that the second countermeasure payload 104B of the selected countermeasure expendable 100 has been used. The sequencer 10 may record or keep this information to determine that the selected countermeasure expendable 100 has two less countermeasure payloads 104 available.

As illustrated in FIG. 6D, the sequencer 10 sends a third signal to countermeasure expendable 100 via the firing pin operably engaged with said countermeasure expendable 100. The third signal sent by the sequencer 10 is relayed from the electrical block 130, through the connector pins 134, and to a third countermeasure payload 104C, via the bridge wire 136, to fire the third countermeasure payload 104C. The third signal sent by the sequencer 10 to the third countermeasure payload 104C includes a third voltage “V₃” that may overcome the second Zener voltage threshold “VZ2” of the second Zener diode “D2”. In one exemplary embodiment, a third voltage of a third signal sent from a sequencer to a countermeasure expendable may be in a range from about seventeen volts up to about nineteen volts when five amps is conducted through a one-ohm squib. The third voltage “V₃” of the third signal sent by the sequencer 10 is greater than the first and second voltages “V₁”, “V₂” of the first and second signals. The third voltage “V₃” of the third signal is greater than the second Zener voltage threshold “VZ2” so that the third signal is able to pass through the second Zener voltage threshold “VZ2” of the second Zener diode “D2” of the third countermeasure payloads 104C and ejects the third countermeasure payloads 104C.

Still referring to FIG. 6D, the third signal sent to the third countermeasure payload 104C initiates an ignitable energy pellet 140 of the third countermeasure payload 104C. Once initiated, the ignitable energy pellet 140 sends/propels energy into a pressure chamber 142 of the impulse cartridge 105A. The energy propelled by the ignitable energy pellet 140 is denoted by an arrow labeled “E3.” Once the energy is sent into the pressure chamber 142, the pressure chamber 142 directs the energy towards a fuse 144 of the third countermeasure payload 104C to ignite the fuse 144. Additionally, the energy directed from the pressure chamber 142 also provides a suitable amount of force to eject the third countermeasure payload 104C and the associated countermeasure packet 105B from the container 102. Upon ejection, the countermeasure material 106 remains inside of the countermeasure packet 105B of the third countermeasure payload 104C due to time delay of the fuse 144. As such, the fuse 144 ignites a bursting charge 146 of the third countermeasure payload 104C after the third countermeasure payload 104C is ejected from the container 102.

As the fuse 144 reaches the bursting charge 146, the bursting charge 146 is enabled by the fuse 144 to rupture and/or open the countermeasure packet 105B of the third countermeasure payload 104C outside of the container 102 and away from the platform 1 (substantially similar to the first countermeasure payload 104A shown in FIG. 66). Once ruptured, the countermeasure material 106 loaded inside of the countermeasure packet 105B is ejected away from the container 102 and into the surrounding environment of platform 1 to deter enemy threats away from the said platform (see FIG. 1 for such deterrence). Once the third countermeasure payload 104C has been ejected and dispensed from the platform 1, a third relayed signal is returned back to the sequencer 10 to signify that the third countermeasure payload 104C of the selected countermeasure expendable 100 has been used. The sequencer 10 may record or keep this information to determine that the selected countermeasure expendable 100 is empty and/or fails to provide any more countermeasure payloads 104 from the selected countermeasure expendable 100.

Once the selected countermeasure expendable 100 has ejected and dispensed each countermeasure payload 104, the sequencer 10 may repeat the same process of sending signals and/or pulses with different voltages to different countermeasure expendables 100. As such, the sequencer 10 may variably repeat or continuously repeat the processes described above until each and every countermeasure payload 104 of each countermeasure expendable 100 loaded into a magazine 12 has been ejected and dispensed from the platform 1.

The circuitry of the countermeasure expendable 100 illustrated in FIG. 5 is considered advantageous because the inclusion of the Zener diodes allows the sequencer 10 of the CMDS 6 to fire countermeasure payloads 104 variably and independently during a military operation. With this variability and independent firing of the countermeasure payloads 104, the CMDS 6 may conserve the use of countermeasure material or dispense substantial volumes of countermeasure material based on the type or number of enemy threats targeting the platform 1. In addition, the circuitry of the countermeasure expendable 100 allows for the use of legacy parts and components of the legacy CMDS used in the platform 1. In other words, the circuitry of the countermeasure expendable 100 allows for retrofitting these countermeasure expendables 100 with legacy magazines, such as magazine 12, legacy breechplates, legacy dispensers, legacy sequencers, such as sequencer 10, legacy wiring harnesses, and other legacy components and parts provided on the platform 1.

In one exemplary embodiment, each countermeasure payload described and illustrated herein may include a device or apparatus that prevents ignition of a fuse prior to each countermeasure payload exiting a container and a platform. In this embodiment, such use of a device or apparatus provides a safety mechanism that prevents against a countermeasure payload from dispensing and ejecting countermeasure material inside of a container if the countermeasure payload never fully ejects outside of the container and away from the platform.

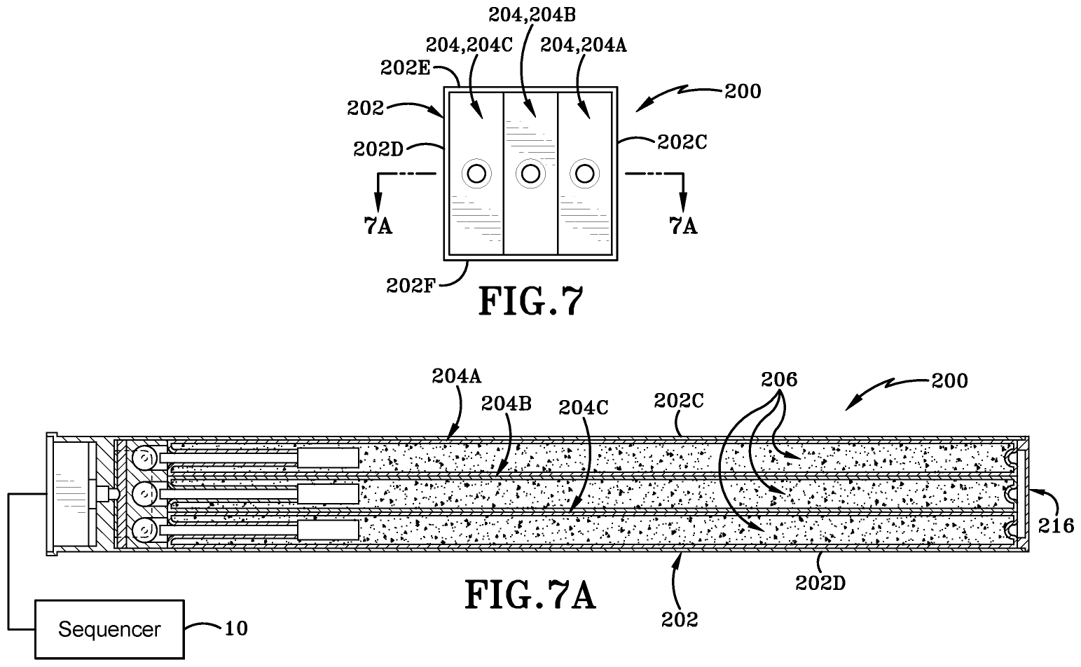

FIGS. 7 and 7A illustrates an alternative countermeasure expendable 200. The alternative countermeasure expendable 200 is substantially similar to the countermeasure expendable 100 illustrated in FIGS. 1 through 6F, except as detailed below.

As illustrated in FIGS. 7 and 7A, each countermeasure payload of a plurality of countermeasure payloads 204 are arranged in a side-by-side configuration inside of a container 202 as compared to the plurality of countermeasure payloads 104 being arranged in an end-to-end configuration as illustrated in FIGS. 1 through 6F and as described above. This alternative arrangement of the countermeasure payloads 204 may allow for greater volumes of countermeasure material to be stored inside a countermeasure packet 205B of each countermeasure payload 204. In addition, the electrical circuitry and operation of the countermeasure expendable 200 is substantially identical to the countermeasure expendable 100 described and illustrated herein.

In the illustrated embodiment, a cover 216 may be used to maintain first, second, and third countermeasure payloads 204A, 204B, 204C to maintain a volume of countermeasure material 206 provided inside each countermeasure payload 204. In addition, each countermeasure payload 204 may have a separate cover to maintain a volume of countermeasure material 206 provided inside each countermeasure payload. In one exemplary embodiment, first, second, and third countermeasure payloads may have a first cover, a second cover, and a third cover to maintain the volume of countermeasure material provided inside each countermeasure payload. In another exemplary embodiment, a single cover may be maintained over first, second, and third countermeasure payloads to maintain a volume of countermeasure material provided inside each countermeasure payload.

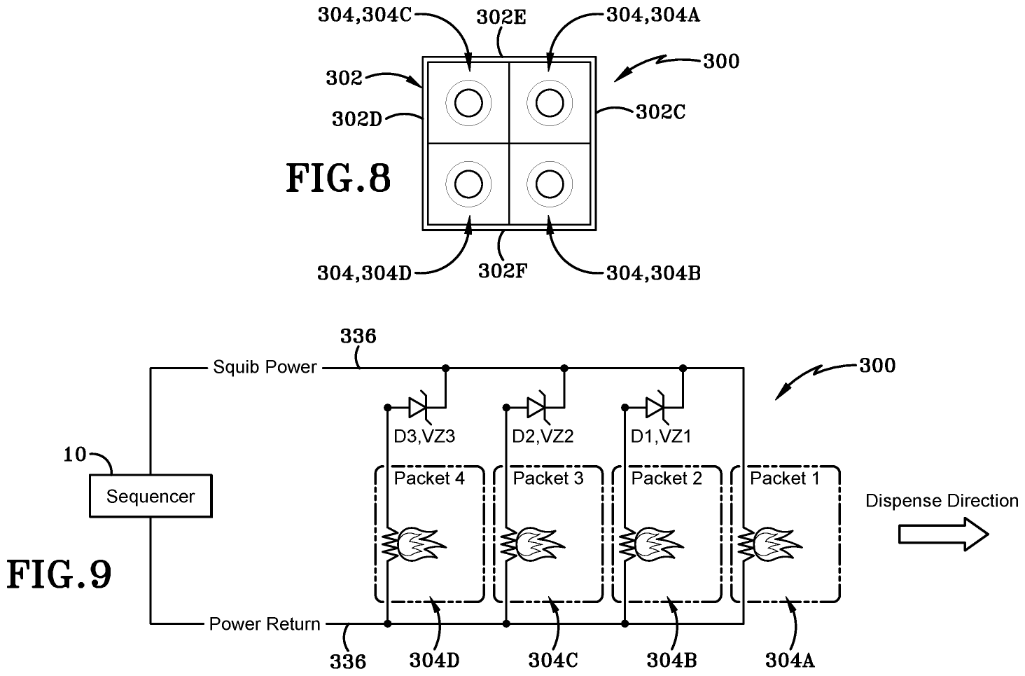

FIGS. 8 and 9 illustrates another alternative countermeasure expendable 300. The alternative countermeasure expendable 300 is substantially similar to the countermeasure expendable 100 illustrated in FIGS. 1 through 6D and the countermeasure expendable 200 illustrated in FIGS. 7 and 7A, except as detailed below.

In this illustrated embodiment, the countermeasure expendable 300 is similar to the countermeasure expendable 200 based on the configuration of a plurality of countermeasure payloads 304 provided inside of a container 302 of the countermeasure expendable 300. As illustrated in FIG. 8, each countermeasure payload of the plurality of countermeasure payloads 304 are arranged in a side-by-side configuration inside of the container 302 similar to the plurality of countermeasure payloads 204 being configured in a side-by-side configuration as illustrated in FIGS. 7 and 7A and described above. In this illustrated embodiment, however, the countermeasure expendable 300 includes more countermeasure payloads than the countermeasure expendables 100, 200 described and illustrated herein. As such, the countermeasure expendable 300 may include more countermeasure payloads than the countermeasure expendables 100, 200 as desired by a user of such countermeasure expendables 300. In the illustrated embodiment, the plurality of countermeasure payloads 304 of the countermeasure expendable 300 uses a total of four countermeasure payloads that are arranged in a side-by-side configuration.

Each countermeasure payload 304 may have a cover (not illustrated) to maintain a volume of countermeasure material 306 provided inside each of the first, second, third, and fourth countermeasure payloads 304A, 304B, 304C, 304D. In one exemplary embodiment, each countermeasure payload may have multiple covers to maintain a volume of countermeasure material provided inside each countermeasure payload. For example, first, second, third, and fourth countermeasure payloads may have a first cover, a second cover, a third cover, and a fourth cover to maintain a volume of countermeasure material provided inside each countermeasure payload.

As illustrated in FIG. 9, the electrical circuitry of the countermeasure expendable 300 is substantially similar to the electrical circuitry of the countermeasure expendable 100 described and illustrated herein. However, the countermeasure expendable 300 include an additional countermeasure payload 304 with an additional Zener diode.

Referring to FIG. 9, the sequencer 10 is electrically connected to a first countermeasure payload 304A via a bridge wire 336. The bridge wire 336 allows the sequencer 10 to be in series with the countermeasure expendable 300 such that the first countermeasure payload 304A is free from any electrical impediment devices or components. Still referring to FIG. 9, the sequencer 10 is also electrically connected to a second countermeasure payload 304B via the bridge wire 336. The bridge wire 336 allows the sequencer 10 to be in series with the second countermeasure expendable 304B. However, a first Zener diode “D1” may be embedded with the second countermeasure payload 304B such that the sequencer 10 is in series with the first Zener diode “D1” and the second countermeasure payload 304B. The first Zener diode “D1” that is embedded in the second countermeasure payload 304B has a first Zener voltage threshold “VZ1” that may be overcome by a required first voltage “V₁” substantially similar to the first Zener diode “D1” that is embedded in the second countermeasure payload 104B as detailed above. Still referring to FIG. 9, the sequencer 10 is also electrically connected to a third countermeasure payload 304C via the bridge wire 336. The bridge wire 336 allows the sequencer 10 to be in series with the third countermeasure expendable 304C. However, a second Zener diode “D2” may be embedded in the third countermeasure payload 304C such that the sequencer 10 is in series with the second Zener diode “D2” and the third countermeasure payload 304C. The second Zener diode “D2” that is embedded in the third countermeasure payload 304C has a second Zener voltage threshold “VZ2” that must be overcome by a required second voltage “V2” substantially similar to the second Zener diode “D2” that is embedded in the third countermeasure payload 104C as detailed above. Still referring to FIG. 9, the sequencer 10 is also electrically connected to a fourth countermeasure payload 304D via the bridge wire 336. The bridge wire 336 allows the sequencer 10 to be in series with the fourth countermeasure expendable 304D. However, a third Zener diode “D3” may be embedded in the fourth countermeasure payload 304D such that the sequencer 10 is in series with the third Zener diode “D3” and the fourth countermeasure payload 304D. The third Zener diode “D3” that is embedded in the fourth countermeasure payload 304D has a third Zener voltage threshold “VZ3” that must be overcome by a required third voltage “V₃”. In the illustrated embodiment, the third Zener voltage threshold “VZ3” of the third Zener diode “D3” is greater than the first and second Zener voltage thresholds “VZ1”, “VZ2” of the first and second Zener diode “D1”, “D2”.

In addition, the countermeasure expendable 300 may be operated and used in a substantially similar way as the countermeasure expendable 100 illustrated and described herein. However, the sequencer 10 may send a fourth signal to countermeasure expendable 300 via a firing pin operably engaged with said countermeasure expendable 300. The fourth signal sent by the sequencer 10 is relayed from an electrical block (not illustrated) to the fourth countermeasure payload 304D, via the bridge wire 336, to fire said fourth countermeasure payload 304D. The fourth signal sent by the sequencer 10 to the fourth countermeasure payload 304D includes a fourth voltage “V₄” is able to overcome the third Zener voltage threshold “VZ3”. In one exemplary embodiment, a fourth voltage of a fourth signal sent from a sequencer to a countermeasure expendable may be in a range from about twenty-two volts up to about twenty-four volts when five amps is conducted through a one-ohm squib. The fourth voltage “V₄” of the fourth signal sent by the sequencer 10 is greater than first, second, and third voltages “V₁”, “V₂”, “V₃” of first second, and third signals sent by the sequencer 10 to first, second, and third countermeasure payloads 304A, 304B, 304C. The fourth voltage “V₄” of the fourth signal is greater than the third Zener voltage threshold “VZ3” so that the fourth signal is able to pass through the third Zener voltage threshold “VZ3” of the third Zener diode “D3” of the fourth countermeasure payloads 304D to eject the fourth countermeasure payloads 304D.

In the illustrated embodiment, the expansion of countermeasure payloads 104, 204, 304 used in container 102, 202, 302 described and illustrated herein used a container with the dimensions of 1″×1″×8″. In other exemplary embodiments, such expansion of countermeasure payloads may be included in any suitable container that is currently be used or may be used during a military operation. Such container may be selected based on the size, shape, and configuration of the countermeasure payloads loaded into a magazine, the amount of electrical power available to eject and dispense the countermeasure payloads, and other various considerations. In one exemplary embodiment, an expansion of countermeasure payloads may be used in a container with the dimensions of 1″×2″×8″. In another exemplary embodiment, an expansion of countermeasure payloads may be used in a container with the dimensions of 1″×2″×8″. In another exemplary embodiment, an expansion of countermeasure payloads may be used in a container with the dimensions of 2″×2.5″×8″.

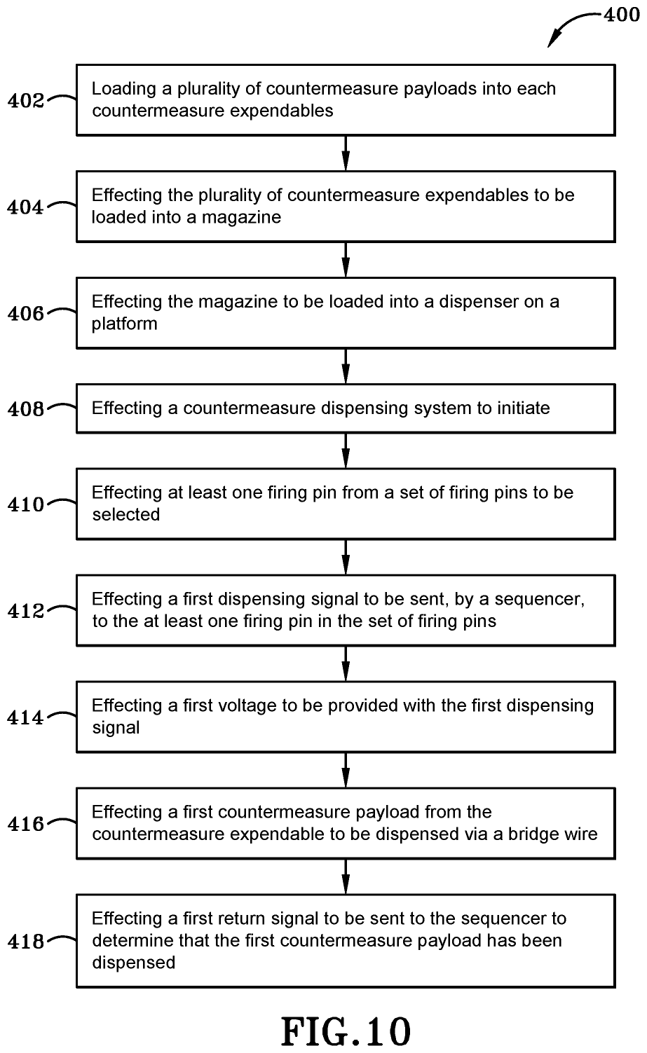

FIG. 10 illustrates a method 400. An initial step 402 of method 400 comprises loading a plurality of countermeasure payloads into each countermeasure expendables of a plurality of countermeasure expendables. Another step 404 comprises effecting the plurality of countermeasure expendables to be loaded into a magazine. Another step 406 comprises effecting the magazine to be loaded into a dispenser on a platform. Another step 408 comprises effecting a countermeasure dispensing system to initiate. Another step 410 comprises effecting at least one firing pin from a set of firing pins to be selected, wherein the at least one firing pin from the set of firing pins is electrically connected to a countermeasure expendable from the plurality of countermeasure expendables. Another step 412 comprises effecting a first dispensing signal to be sent, by a sequencer, to the at least one firing pin in the set of firing pins. Another step 414 comprises effecting a first voltage to be provided with the first dispensing signal. Another step 416 comprises effecting a first countermeasure payload from the countermeasure expendable to be dispensed via a bridge wire operably connecting the at least one firing pin with the first countermeasure payload. Another step 418 comprises effecting a first return signal to be sent to the sequencer to determine that the first countermeasure payload has been dispensed.

In an exemplary embodiment, method 400 may include additional steps. The step of effecting a first voltage to be provided with the first dispensing signal includes the first voltage being less than a first Zener voltage of a first Zener diode that is in series with the sequencer. Optional steps may further provide effecting a second dispensing signal to be sent, by the sequencer, to the at least one firing pin in the set of firing pins; effecting a second voltage to be provided with the second dispensing signal, wherein the first Zener diode is in series with the sequencer; effecting a second countermeasure payload from the countermeasure expendable to be dispensed via the bridge wire operably connecting the at least one firing pin with the second countermeasure payload, wherein the first Zener diode is in series with the second countermeasure payload; and effecting a second return signal to be sent to the sequencer to determine that the second countermeasure payload has been dispensed. The step of effecting a second voltage to be provided with the second dispensing signal includes the second voltage being greater than the first Zener voltage threshold of the first Zener diode. Optional steps may further provide effecting a third dispensing signal to be sent, by the sequencer, to the at least one firing pin in the set of firing pins; effecting a third voltage to be provided with the third dispensing signal, wherein the second Zener diode is in series with the sequencer; effecting a third countermeasure payload from the countermeasure expendable to be dispensed via the bridge wire operably connecting the at least one firing pin with the third countermeasure payload, wherein the second Zener diode is in series with the third countermeasure payload; and effecting a third return signal to be sent to the sequencer to determine that the third countermeasure payload has been dispensed. The step of effecting a third voltage to be provided with the third dispensing signal includes the third voltage being greater than the second Zener voltage threshold of the second Zener diode. Optional steps may further provide effecting a fourth dispensing signal to be sent, by the sequencer, to the at least one firing pin in the set of firing pins; effecting a fourth voltage to be provided with the fourth dispensing signal, wherein the third Zener diode is in series with the sequencer; effecting a fourth countermeasure payload from the countermeasure expendable to be dispensed via the bridge wire operably connecting the at least one firing pin with the fourth countermeasure payload, wherein the third Zener diode is in series with the fourth countermeasure payload; and effecting a fourth return signal to be sent to the sequencer to determine that the fourth countermeasure payload has been dispensed. The step of effecting a fourth voltage to be provided with the fourth dispensing signal includes the fourth voltage being greater than the third Zener voltage threshold of the third Zener diode. An optional step may further provide positioning each countermeasure payload of the plurality of countermeasure payloads in an end-to-end configuration inside a countermeasure expendable of the plurality of countermeasure expendables. An optional step may further provide positioning each countermeasure payload of the plurality of countermeasure payloads in a side-by-side configuration inside a countermeasure expendable of the plurality of countermeasure expendables

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A countermeasure expendable, comprising:
a container; and
a plurality of countermeasure payloads operably engaged inside the container, wherein one countermeasure payload of the plurality of countermeasure payloads is operably connected to a first Zener diode, and wherein another countermeasure packet of the plurality of countermeasure payloads is operably connected to a second Zener diode.

2. The countermeasure expendable of claim 1, wherein the first Zener diode has a first Zener voltage threshold and the second Zener diode has a second Zener voltage threshold greater than the first Zener voltage threshold.

3. The countermeasure expendable of claim 1, the plurality of countermeasure payloads further comprising:
a first countermeasure payload;
a second countermeasure payload operably connected to the first Zener diode having a first Zener voltage threshold; and
a third countermeasure payload operably connected to the second Zener diode having a second Zener voltage threshold greater than the first Zener voltage threshold.

4. The countermeasure expendable of claim 3, wherein the first countermeasure payload is adapted to be dispensed at a first voltage via a sequencer operably engaged to said first countermeasure payload.

5. The countermeasure expendable of claim 4, wherein the second countermeasure payload is adapted to be dispensed at a second voltage via the sequencer operably engaged to said second countermeasure payload, and wherein the second voltage is greater than the first voltage.

6. The countermeasure expendable of claim 5, wherein the third countermeasure payload is adapted to be dispensed at a third voltage via the sequencer operably engaged to said third countermeasure payload, and wherein the third voltage is greater than the first and second voltages.

7. The countermeasure expendable of claim 6, further comprising:
a fourth countermeasure payload operably connected to a third Zener diode having a third Zener voltage threshold greater than the first Zener voltage threshold and the second Zener voltage threshold.

8. The countermeasure expendable of claim 7, wherein the fourth countermeasure payload is adapted to be dispensed at a fourth voltage via the sequencer operably engaged to said fourth countermeasure payload, and wherein the fourth voltage is greater than the first voltage, the second voltage, and the third voltage.

9. The countermeasure expendable of claim 1, wherein each countermeasure payload of the plurality of countermeasure payloads is arranged end-to-end inside of the container.

10. The countermeasure expendable of claim 1, wherein each countermeasure payload of the plurality of countermeasure payloads is arranged side-by-side inside of the container.

11. A method, comprising:
loading a plurality of countermeasure payloads into each countermeasure expendable of a plurality of countermeasure expendables;
effecting the plurality of countermeasure expendables to be loaded into a magazine;
effecting the magazine to be loaded into a dispenser on a platform;
effecting a countermeasure dispensing system to initiate;
effecting at least one firing pin from a set of firing pins to be selected, wherein the at least one firing pin from the set of firing pins is electrically connected to a countermeasure expendable from the plurality of countermeasure expendables;
effecting a first dispensing signal to be sent, by a sequencer, to the at least one firing pin in the set of firing pins;
effecting a first voltage to be provided with the first dispensing signal;
effecting a first countermeasure payload from the countermeasure expendable to be dispensed via a bridge wire operably connecting the at least one firing pin with the first countermeasure payload; and
effecting a first return signal to be sent to the sequencer to determine that the first countermeasure payload has been dispensed.

12. The method of claim 11, wherein the step of effecting a first voltage to be provided with the first dispensing signal includes the first voltage being less than a first Zener voltage of a first Zener diode that is in series with the sequencer.

13. The method of claim 12, further comprising:
effecting a second dispensing signal to be sent, by the sequencer, to the at least one firing pin in the set of firing pins;
effecting a second voltage to be provided with the second dispensing signal, wherein the first Zener diode is in series with the sequencer;
effecting a second countermeasure payload from the countermeasure expendable to be dispensed via the bridge wire operably connecting the at least one firing pin with the second countermeasure payload, wherein the first Zener diode is in series with the second countermeasure payload; and
effecting a second return signal to be sent to the sequencer to determine that the second countermeasure payload has been dispensed.

14. The method of claim 13, wherein the step of effecting a second voltage to be provided with the second dispensing signal includes the second voltage being greater than the first Zener voltage threshold of the first Zener diode.

15. The method of claim 14, further comprising:
effecting a third dispensing signal to be sent, by the sequencer, to the at least one firing pin in the set of firing pins;
effecting a third voltage to be provided with the third dispensing signal, wherein the second Zener diode is in series with the sequencer;
effecting a third countermeasure payload from the countermeasure expendable to be dispensed via the bridge wire operably connecting the at least one firing pin with the third countermeasure payload, wherein the second Zener diode is in series with the third countermeasure payload; and
effecting a third return signal to be sent to the sequencer to determine that the third countermeasure payload has been dispensed.

16. The method of claim 15, wherein the step of effecting a third voltage to be provided with the third dispensing signal includes the third voltage being greater than the second Zener voltage threshold of the second Zener diode.

17. The method of claim 16, further comprising:
effecting a fourth dispensing signal to be sent, by the sequencer, to the at least one firing pin in the set of firing pins;
effecting a fourth voltage to be provided with the fourth dispensing signal, wherein the third Zener diode is in series with the sequencer;
effecting a fourth countermeasure payload from the countermeasure expendable to be dispensed via the bridge wire operably connecting the at least one firing pin with the fourth countermeasure payload, wherein the third Zener diode is in series with the fourth countermeasure payload; and
effecting a fourth return signal to be sent to the sequencer to determine that the fourth countermeasure payload has been dispensed.

18. The method of claim 17, wherein the step of effecting a fourth voltage to be provided with the fourth dispensing signal includes the fourth voltage being greater than the third Zener voltage threshold of the third Zener diode.

19. The method of claim 11, further comprising:
positioning each countermeasure payload of the plurality of countermeasure payloads in an end-to-end configuration inside a countermeasure expendable of the plurality of countermeasure expendables.

20. The method of claim 11, further comprising:
positioning each countermeasure payload of the plurality of countermeasure payloads in a side-by-side configuration inside a countermeasure expendable of the plurality of countermeasure expendables.
